(19) United States
(12) Patent Application Publication
(10) Pub. No.: US 2023/0309593 A1
(43) Pub. Date: Oct. 5, 2023

(54) Onion Food Product and Methods of Making and Use Thereof

(71) Applicant: Olam Americas, LLC, Fresno, CA (US)

(72) Inventors: Neil Muller, Fresno, CA (US); James Hastings, Fresno, CA (US); Quinn Zweigle, Fresno, CA (US); Shannon Arballo, Fresno, CA (US)

(73) Assignee: Olam Americas, LLC, Fresno, CA (US)

(21) Appl. No.: 18/208,148

(22) Filed: Jun. 9, 2023

Related U.S. Application Data
(63) Continuation-in-part of application No. 17/458,666, filed on Aug. 27, 2021.
(60) Provisional application No. 63/070,854, filed on Aug. 27, 2020.

(51) Int. Cl. A23L 19/20; A23L 19/00; A23B 7/10; A23B 7/157; B65B 25/04; B65B 55/00; B65B 7/28

(52) U.S. Cl. CPC A23L 19/20; A23L 19/03; A23B 7/10; A23B 7/157; B65B 25/041; B65B 55/00; B65B 7/28

(57) ABSTRACT

An onion product containing sodium metabisulfite, flavors, a food-grade acid, onions, flavor, onions, and an acidified solution comprising water and a food-grade acid, which makes it possible for an onion food product to achieve commercial sterility. Although makeable in other ways, an onion product results from a four-step fill process, including dosing sodium metabisulfite, liquid dosing of heat-stable flavors, onions, acidified solution comprising water and a food-grade acid, into a container, sterilizing, and optionally inverting the container.

### CROSS-REFERENCE TO RELATED APPLICATIONS

The present application is a continuation-in-part of U.S. patent application Ser. No. 17/458,666, filed Aug. 27, 2021, which claims priority benefit of U.S. Provisional Application No. 63/070,854, filed Aug. 27, 2020, which application is hereby incorporated herein by reference in its entirety.

### FIELD

The present description concerns onions in an aqueous brine or acidified solution having one or more acids chosen from lactic acid, citric acid, and phosphoric acid; and at least one acid chosen from ascorbic acid and bisulfite, or derivatives of bisulfite. In another aspect of the invention, a four-stage fill process is used to prepare a shelf-stable onion product. Although makeable in other ways, the onions in the aqueous brine or acidified solution are sealable in a container, and inverted and heated.

### INTRODUCTION

Rehydrating or hydrating onions involves concerns regarding uniform hydration, onion browning upon heating, onion flavor, onion separation and clumping, natural sweetening, and storage shelf life of the packaged onions. For example, pickling alters onions flavor.

Objects and advantages of the embodiments will be set forth in part in the description which follows, and in part will be obvious from the description, or may be learned by practice of the description. Objects and advantages of the description will be realized and attained by means of the elements and combinations particularly pointed out in the appended claims.

It is to be understood that both the foregoing general description and the following detailed description are exemplary and explanatory only and are not restrictive of any invention, as claimed.

The accompanying drawings, which are incorporated in and constitute a part of this specification, illustrate embodiments and together with the description, serve to explain the principles.

### BRIEF DESCRIPTION OF THE DRAWINGS

FIG. 1A is an embodiment of a container. FIG. 1B is an embodiment of a container from FIG. 1A but inverted.

### EMBODIMENTS

Reference will now be made in detail to embodiments, examples of which are illustrated in the accompanying drawings. Wherever possible, the same reference numbers will be used throughout the drawings to refer to the same or like parts.

Ranges: throughout this disclosure, various aspects of the disclosure can be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

It is understood that any and all whole or partial integers between any ranges set forth herein are included herein.

An onion food product comprises onions in an aqueous brine which comprises at least one acid chosen from lactic acid, citric acid, malic acid, fumaric acid, and phosphoric acid; and at least one acid chosen from ascorbic acid and bisulfite or derivatives thereof, and water, and the aqueous brine has a pH ranging from 1.5 to 4.5.

In some embodiments, the onions have a form chosen from chopped, diced, minced, and sliced onions. In some embodiments, the onions have a form chosen from whole and peeled onions.

In some embodiments, the onions are made from dehydrated, fresh, or frozen onions.

In some embodiments, the onion food product further comprises at least one vegetable other than onions or at least one spice, but the onion is the major vegetable ingredient by weight of any vegetables and spices.

In particular, the onions have a weight percentage amount Wt % relative to total weight of the onions and any other optional vegetables and spices. The term, Wt % (drained onions), refers to the weight percent of the drained onions (if needed) relative to any other optional drained vegetables and spices including the onions.

$$Wt \% ( onions ) = \frac{wt ( onions )}{wt ( ingredients )} \times 100 \%$$

For example, onions, other optional vegetables, and optional spices are drained (if wet) and the drained (if wet) onions, other optional vegetables, and optional spices are weighed. The results are, e.g., as follows:

| | | | |
|---|---|---|---|
| Wt (onions) | 99.00 | g | Wt %(onions) = 99.00% |
| Wt (peppers) | 0.99 | g | Wt %(peppers) = 0.99% |
| Wt (parsley) | 0.01 | g | Wt %(parsley) = 0.01% |
| Wt (ingredients) | 100.00 | g | Wt %(ingredients) = 100% |

In some embodiments, the onions are present in an amount Wt % (onions) above 50%, 60%, 70%, 80%, 90%, 95%, 98%, 99%, 99.9% or 100%. In some embodiments the onions are present in an amount Wt % (onions) ranging from 55% to 98%, from 60% to 95%, or from 70% to 85%.

In some embodiments, the onion food product further comprises at least one spice, but the onion is the major vegetable ingredient by weight of any optional vegetables and spices. In some embodiments, the at least one spice is chosen from parsley, basil, oregano, sage, tarragon, and thyme. In some embodiments, the at least one spice is present in an amount Wt % (spice) less than 10% or 1% or 0.1% or 0.01% or 0.001% by weight of any optional vegetables and spices.

In some embodiments, the onion food product further comprises at least one vegetable different than onion, but the onion is the major vegetable ingredient by weight of any optional vegetables and spices. In some embodiments, the other vegetables are chosen from broccoli, mushrooms, squash, zucchini, garlic, and peppers. In some embodiments, the at least one vegetable different than onion is present in an amount Wt % (other vegetables) greater than 0% but less than 3%, 5%, 7.5%, 15%, 20%, 25%, 30%, 35%, 40%, or 45% by weight of any vegetables and spices.

As noted herein, the onions are in an aqueous brine or acidified solution, which comprises water and at least one acid chosen from lactic acid, citric acid, malic acid, fumaric acid, and phosphoric acid; and at least one acid chosen from ascorbic acid and bisulfite.

In some embodiments, the aqueous brine or acidified solution is present in an amount above 15%, 20%, 30%, 40%, or 50% wt % by weight relative to the weight of the onions and aqueous brine or acidified solution.

In some embodiments, the aqueous brine or acidified solution has a liquid part consisting of water. In some embodiments of the aqueous brine, the liquid part comprises water and at least one other liquid. In some embodiments of the aqueous brine or acidified solution, the water is present in an amount greater than 50% v/v relative to the total volume of the water plus the volume of the at least one other liquid. In some embodiments, the amount is greater than 60% v/v or 70% v/v or 96% v/v or 99% v/v. In some embodiments, the amount ranges from 75% to 95% v/v or from 80% to 90% v/v.

Water is obtainable from many sources. The water is potable and suitable for human consumption. In some embodiments, the water is taken from public sources, filtered and/or sterilized.

In some embodiments, the at least one other liquid is an organic liquid suitable for human consumption. In some embodiments, the organic liquid is an edible oil, such as an edible oil of plant, animal or synthetic origin. In some embodiments, the edible oil is chosen from olive oil, soybean oil, sunflower oil, and rapeseed oil.

In some embodiments, the aqueous brine or acidified solution further comprises sodium chloride in an amount ranging from about 1.5 to 20 w/w % by weight of the sodium chloride relative to the water and sodium chloride. In some embodiments, the weight ranges from 6 to 18 w/w % by weight of the sodium relative to the water and sodium chloride.

In some embodiments, the aqueous brine or acidified solution further comprises one or more other brine salts chosen from sodium sulfate, potassium chloride, and calcium chloride. In some embodiments, the one or more other brine salts are present in an amount ranging from 0.1 to 10 w/w % or 0.5 to 4 w/w % of the sodium chloride.

In some embodiments, in the aqueous brine or acidified solution, the lactic acid is present in an amount ranging from 0.1 to 8.0 wt/wt %; the citric acid is present in an amount ranging from 0.01 to 5.0 wt/wt %; and the ascorbic acid is present in an amount ranging from 0.01 to 5.0 wt/wt %, in which wt/wt % refers to the weight relative to the total weight of the lactic acid, citric acid, and ascorbic acid.

Bisulfite is in a form for consumption. For example, the form of bisulfite or derivates thereof such as sodium bisulfite, sodium metabisulfite, bisulfite, sulfite, sulfur dioxide.

In some embodiments, in the aqueous brine or acidified solution, the lactic acid is present in an amount ranging from 0.1 to 8.0 wt/wt %; the citric acid is present in an amount ranging from 0.01 to 5.0 wt/wt %; and sodium bisulfite is present in an amount ranging from 0.01 to 1.25 wt/wt %, in which wt/wt % refers to the weight relative to the total weight of the lactic acid, citric acid, and sodium bisulfite. The relative amount of bisulfite could be determined for other bisulfites by reference to the amount of sodium bisulfite.

In some embodiments, in the aqueous brine or acidified solution, the lactic acid is present in an amount ranging from 0.1 to 8.0 wt/wt %; the citric acid is present in an amount ranging from 0.01 to 5.0 wt/wt %; and phosphoric acid is present in an amount ranging from 0.01 to 1.25 wt/wt %, in which wt/wt % refers to the weight relative to the total weight of the lactic acid, citric acid, and phosphoric acid. The relative amount of phosphoric acid could be determined for various forms (dicalcium phosphate, hexametaphosphate, sodium phosphate, and tricalcium phosphate) by reference to the amount of sodium bisulfite.

In some embodiments, in the aqueous brine or acidified solution, the lactic acid is present in an amount ranging from 0.1 to 8.0 wt/wt %; the citric acid is present in an amount ranging from 0.01 to 5.0 wt/wt %; the ascorbic acid is present in an amount ranging from 0.01 to 5.0 wt/wt %, and sodium bisulfite is present in an amount ranging from 0.01 to 1.25 wt/wt %, in which wt/wt % refers to the weight relative to the total weight of the lactic acid, citric acid, ascorbic acid, and sodium bisulfite. The relative amount of bisulfite could be determined for other bisulfites by reference to the amount of sodium bisulfite.

In some embodiments, in the aqueous brine or acidified solution, the lactic acid is present in an amount ranging from 0.1 to 8.0 wt/wt %; the citric acid is present in an amount ranging from 0.01 to 5.0 wt/wt %; the ascorbic acid is present in an amount ranging from 0.01 to 5.0 wt/wt %, and phosphoric acid is present in an amount ranging from 0.01 to 1.25 wt/wt %, in which wt/wt % refers to the weight relative to the total weight of the lactic acid, citric acid, ascorbic acid, and phosphoric acid. The relative amount of bisulfite could be determined for other bisulfites by reference to the amount of sodium bisulfite.

In some embodiments, in the aqueous brine or acidified solution, the lactic acid is present in an amount ranging from 0.1 to 8.0 wt/wt %; the citric acid is present in an amount ranging from 0.01 to 5.0 wt/wt %; the phosphoric acid is present in an amount ranging from 0.01 to 5.0 wt/wt %, and bisulfite is present in an amount ranging from 0.01 to 1.25 wt/wt %, in which wt/wt % refers to the weight relative to the total weight of the lactic acid, citric acid, ascorbic acid, and phosphoric acid. The relative amount of bisulfite could be determined for other bisulfites by reference to the amount of sodium bisulfite.

In some embodiments, the aqueous brine or acidified solution has a pH ranging from 1.5 to 3.5 or from 1.5 to 4.5.

An onion product comprises a container comprising a compartment containing the onion food product described herein.

A method of nourishing comprises eating the onion food product described herein. In some embodiments, the onion food product is consumed by a human for nourishment.

A method of making an onion food product comprises containing, in a first compartment of a first container, onions and an aqueous brine comprising lactic acid, citric acid, ascorbic acid, and water, and wherein the aqueous brine or acidified solution has a pH ranging from 1.5 to 4.5.

The onion food product is makeable by mixing, in any relative order, onions; any at least one optional vegetable other than onion; any at least one optional spice; water; any at least one optional liquid; any optional brine salts; one or more acids chosen from lactic acid, citric acid, and phosphoric acid; and at least one acid chosen from ascorbic acid and bisulfite.

In some embodiments, the mixing occurs in a first compartment of a first container. In some embodiments, the first compartment of the first container is sealed.

In some embodiments, the method further comprises, containing, in the first compartment of the first container, onions and an aqueous brine comprising one or more acids chosen from lactic acid, citric acid, and phosphoric acid; and at least one acid chosen from ascorbic acid and bisulfite, and water; the aqueous brine has a pH ranging from 1.5 to 4.5 or another pH described herein; and the aqueous brine has a temperature maintained above 165° F. for at least 15 minutes. The temperature and period of time are sufficient to sterilize the inside of the first compartment of the first container and its contents. In some embodiments, the temperature is above 175° F., 180° F., 188° F. or 198° F., or the temperature ranges from 188 to 211° F. In some embodiments, the period of time ranges from 15 minutes to 360 minutes or from 45 minutes to 200 minutes.

In some embodiments, the method further comprises inverting the first compartment of the first container while maintaining the aqueous brine at a temperature above 165° F. for at least 15 minutes (or other described temperature or time).

The two or three or four or five acids—one or more acids chosen from lactic acid, citric acid, and phosphoric acid; and at least one acid chosen from ascorbic acid and bisulfite— make the resultant onion food product to be smoother in flavor. If only one of the two or three or four or five acids were used, the acidic bite would make the resultant onion food product's flavor is less desirable. The two or three or four or five acids—one or more acids chosen from lactic acid, citric acid, and phosphoric acid; and at least one acid chosen from ascorbic acid and bisulfite— makes it possible for the resultant onion food product to slow browning and/or Maillard Browning, which tends to occur after about one month when, e.g., ascorbic acid and bisulfite or derivatives thereof is absent from the three acids. However, in some aspects, the browning may occur almost immediately after processing.

In some embodiments, aqueous brine or acidified solution is made from mixing the two or three or four or five acids—one or more acids chosen from lactic acid, citric acid, and phosphoric acid; and at least one acid chosen from ascorbic acid and bisulfite—and water. In some embodiments, the two or three or four or five acids—one or more acids chosen from lactic acid, citric acid, and phosphoric acid; and at least one acid chosen from ascorbic acid and bisulfite—are mixed as aqueous solutions from storage vessels (totes, drums, tanks, or bulk containers) containing the aqueous acid a given strength (5%, 10%, 15%, 20%, 25%, 30%, 35%, 40%, 45%, 50%, etc.). In some embodiments, the aqueous brine or acidified solution is made from mixing the conjugate base of one or more of the three to five acids and water. In some embodiments, sodium bisulfite is mixed with water. In some embodiments, dicalcium phosphate, hexametaphosphate, sodium phosphate, or tricalcium phosphate is mixed with water.

In some embodiments, the method further comprises containing, in the first compartment of the first container, onions and water. In some embodiments, the water is already in the form of the aqueous brine or acidified solution. In some embodiment, the method further comprises adding at least one optional other brine salts to the water to make a precursor to the aqueous brine. In some embodiments, the method further comprises thereafter adding, to the water and onions; one or more acids chosen from lactic acid, citric acid, and phosphoric acid; and at least one acid chosen from ascorbic acid and bisulfite; to result in the aqueous brine or acidified solution having a pH ranging from 1.5 to 4.5 or other desired pH disclosed herein, thereafter heating the aqueous brine or acidified solution to a temperature above 165° F. or other desired temperature disclosed herein, and thereafter maintaining the aqueous brine at a temperature above 165° F. for at least 15 minutes (or other desired temperature and time disclosed herein). In some embodiments, the aqueous brine is heated to have a temperature elevated from room temperature (70° F.) to the temperature above 165° F. or 175° F. or 180° F. 188° F. or 198° F., or the temperature ranges from 188 to 211° F. As noted above, the period of time ranges from 15 minutes to 360 minutes or from 45 minutes to 200 minutes.

And as noted above, in some embodiments, the method further comprises inverting the first compartment of the first container while maintaining the aqueous brine at a temperature above 165° F. for at least 15 minutes (or other described temperature or time).

In some embodiments, the onions are dehydrated, fresh, or frozen.

In some embodiments, the method further comprises transferring, from the first compartment of the first container to a second compartment of a second container, the onions in an aqueous brine comprising one or more acids chosen from lactic acid, citric acid, and phosphoric acid; and at least one acid chosen from ascorbic acid and bisulfite, and water, and wherein the aqueous brine or acidified solution has a pH ranging from 1.5 to 4.5. In some embodiments, the method further comprises thereafter sealing the second container.

In another embodiment, a four-stage fill process is used to make the onion food product. The container that will house the onion food product is first cleaned. The container may be selected from any material that can withstand thermal pasteurization, including, without limitation, glass, polypropylene, high density polyethylene (HDPE), and polyethylene terephthalate material containers.

In one step of the four-stage fill process includes bisulfite is added to the container in an amount between about 0.01-0.1%, such as about 0.01%, 0.02%, 0.03%, 0.04%, 0.05%, 0.06%, 0.07%, 0.08%, 0.09%, 0.1%. In certain aspects the bisulfite or derivative thereof is sodium metabisulfite. The bisulfite may be present as a liquid or solid. In further examples, the bisulfite is sodium metabisulfite (SMBS) in a dry powder form.

In another step of the four-stage fill process includes liquid dosing of heat stable flavors to the container. The heat stable flavors may use glycerin, propylene glycol, and oil as a carrier. In one aspect the heat stable flavor is a natural flavor. The natural flavor may include a top-note and/or a fore-note. In one example, the top-note natural flavor is fresh onion optionally further including subtitles of green onion. This top-note flavor may be propylene glycol based and designated to deactivate at 250° F. In another example, the fore-note is a natural flavor, added from about 0.1-3%, such as about 0.35% and capable of surviving temperatures greater than 250° F. Organic, natural, and artificial flavors may also be used in certain embodiments. The flavor is added in an amount between about 0.1-2%, such as about 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%.

Another step of the four-stage fill process includes adding the onion to the container. The onions may be dehydrated, fresh or frozen. In one example, the onion is cut in about ¼″ or greater pieces. The onion is present in an amount of about 15-25%, such as about 15%, 15.5%, 16%, 16.5%, 17%, 17.5%, 18%, 18.5%, 19%, 19.5%, 20%, 20.5%, 21%, 21.5%, 22%, 22.5%, 23%, 23.5%, 24%, 24.5%, 25%, of the total volume of the product.

In the last stage of the fill process, an acidified solution comprising water and a food grade acid is added to the container. The food grade acid can be any food-grade acid. Non-limiting examples include, without limitation, citric acid, ascorbic acid, fumaric acid, malic acid, lactic acid and phosphoric acid. In certain examples, the food grade acid may be a combination of one or more food-grade acids. The food grade acid is present in an amount of between about 0.1-2% of the total volume of the finished product, such as 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2% of the finished product. The water used in the process may be any potable water. The water is present in an amount of between about 71-84% of the total volume of the product, such as about 71%, 71.5%, 72%, 72.5%, 73%, 73.5%, 74%, 74.5%, 75%, 75.5%, 76%, 76.5%, 77%, 77.5%, 78%, 78.5%, 79%, 79.5%, 80%, 80.5%, 81%, 81.5%, 82%, 82.5%, 83%, 83.5%, 84%. The pH of the finished product is about 4.0 or less, such as about 3.9 or less, about 3.8 or less or about 3.7 or less, and have a brine acid of about 1.00% or less.

The container is capped within about 30 seconds of adding the acidified solution. In one example, following filling, the container is tilted on its side and rolled or twisted to agitate contents in about 45 seconds or less to avoid hard packing in the container as a result of onion hydration or swelling. Any type of cap or lid configured to seal the container is contemplated herein. Nonlimiting examples include a lug-type cap or continuous-thread (CT) type cap.

The container may be heated to a temperature of about 190° F. or greater with a jar fit temperature of about 190° F. or greater. In one example, the container may be heated to a temperature from about 195-205° F. In one aspect, the container is heated post-inversion in a thermal pasteurizer with hot water sprayers at 195° F. or greater to maintain the internal temperature of the product at 165° F. or greater for 15.4 minutes. For example, the container is heated to 195° F. or greater with a jar fill temperature of 195° F. or greater. Further examples of on cap sterilization parameters are set forth in Table 1 and Table 2 below.

TABLE 1

| Product Temperature (° F.) | Time (minutes) | Time (seconds) |
|---|---|---|
| 150 | 15.7200 | 943.20 |
| 155 | 5.8763 | 352.58 |
| 160 | 2.1966 | 131.80 |
| 165 | 0.8211 | 49.27 |
| 170 | 0.3069 | 17.42 |
| 175 | 0.1147 | 6.88 |
| 180 | 0.0429 | 2.57 |
| 185 | 0.0160 | 0.96 |
| 190 | 0.0060 | 0.36 |
| 195 | 0.0022 | 0.13 |
| 200 | 0.0008 | 0.05 |

TABLE 2

| Minimum Internal | | |
|---|---|---|
| Temperature (° F.) | On Cap Hold | Total Hot Hold |

| | | | | |
|---|---|---|---|---|
| 165 | 2.2 | minutes | 15.4 | minutes |
| 170 | 49.27 | seconds | 7.5 | minutes |
| 175 | 18.42 | seconds | 3.65 | minutes |
| 180 | 6.88 | seconds | 1.8 | minutes |
| 185 | 2.57 | seconds | 1 | minute |

The container housing the onion food product is then inverted on its cap for a minimum of 2.2 minutes and a maximum of 5 minutes. As discussed above, during inversion the container maintains a temperature of about 160° F. or greater, such as about 160° F., 161° F., 162° F., 163° F., 164° F., 165° F., 166° F., 167° F., 168° F., 169° F., 170° F. or greater. In one aspect, the container is heated post-inversion in a thermal pasteurizer with hot water sprayers at 195° F. or greater to maintain the internal temperature of the product at 165° F. or greater for 15.4 minutes. For example, the container is heated to 195° F. or greater with a jar fill temperature of 195° F. or greater. The container housing the onion food product may then be reinverted back on its base and further thermally processed and pasteurized for a minimum of about 13.2 minutes and must maintain 165° F. throughout the thermal pasteurization. The total thermal processing time is about 13-18 minutes, such as about 15-16 minutes, including about 15.1, 15.2, 15.3, 15.4, 15.5, 15.6, 15.7, 15.8, 15.9, or 16 minutes, at a temperature of about 160° F. or greater or alternatively 165° F. or greater. Following thermal processing, the container is cooled to at least about 110° F., such as about 111° F., 112° F., 113, 114° F., 115° F., 116° F., 117° F., 118° F., 119° F., or 120° F. In one aspect, ambient temperature water is used to cool the container. Thereafter the product is further left to cool to ambient temperature. The onion food product is ready for consumption upon cooling. In one example, the onion food product is best consumed 24 hours or more after cooling to allow all ingredients to equilibrate. The onion food product is shelf stable for up to, but not limited to, about 730 days.

Embodiments herein described make it possible to minimizes the heating, which make it possible to lessen the browning of onions that accompanies heating.

Although onions are used as an exemplary vegetable, and as discussed in more detail herein, other vegetables may be used in combination with or in lieu of onions. Nonlimiting examples of such additional vegetables include: carrots, beets, radishes, cauliflower, peppers, green beans, cucumbers, etc. Spices may also be used in accordance with aspects of this disclosure.

The inventors surprisingly found that by utilizing the four-step fill process described herein, certain product attributes were maximized. For example, SMBS and other sulfites in granulated dry powder will rapidly turn into sulfur dioxide gas (SO₂) in the presence of water. Acidified water and increased liquid temperature will substantially speed up this reaction. Moreover, flavor components used in the finished onion product carry sulfites to better match onion profiles. These sulfites can easily degrade under similar conditions of SMBS as explained above, thereby degrading the finished flavor profile and in turn reducing the shelf life of the product. Thus, in a two-step fill process, the food grade acid, water, flavor, and SMBS are added to a kettle and heated to a high temperature, such as 195° F. During this process the sulfites within the SMBS and flavor are boiled or evaporated out and functional properties completely deteriorated. On the other hand, the inventors found that when using the four-step process described herein, the SMBS and flavor is added during the initial stages of the process, thus retaining the sulfite composition in both the SMBS and the flavor. In one aspect, the onion is added after addition of the SMBS and flavor to act as a cap or buffer between the SMBS and flavor to prevent the formation of SO₂. Alternatively, the steps can be performed in any orders, so long as the he hot acidified liquid added in the four-step process completes the fill. Following the addition of the hot acidified liquid the container is capped in enough time to trap and seal all of the added components thereby retaining their functionality and equilibrating overall flavor. By capping the container within 30 seconds or less of adding the acidified solution, the inventors found that the finished product attributes were maximized.

### Example 1. Hot Fill

In the example below, the embodiment refers to chopped onions. But in any embodiment herein, the chopped onions may be accompanied by other vegetables and/or spices.

Dehydrated chopped onions are added to a volumetric filler to a desired amount, e.g., 14 oz, 28 oz, 60 oz. or any desired amount.

The dehydrated onions are added to an open compartment of a container. Aqueous brine or acidified liquid is added to a desired level to the open compartment.

The aqueous brine comprises lactic acid, citric acid, at least one acid chosen from ascorbic acid and bisulfite, and water. In some embodiments, the aqueous brine consists of lactic acid, citric acid, at least one acid chosen from ascorbic acid and bisulfite, and water.

The aqueous brine is made by mixing, e.g., in a batch tank, the two or three or four or five acids—lactic acid, citric acid, and at least one acid chosen from ascorbic acid and bisulfite—or conjugate base thereof, or sodium bisulfite, and water to have a desired pH between 1.5 and 3.5 or 1.5 and 4.5.

The aqueous brine or acidified liquid is transferred in a feeder feed tank or heat exchanger for heating to have a temperature elevated of 188° F. The heated aqueous brine is added to a desired level to the open compartment of the container after the dehydrated onions are added to an opening in a container.

The compartment of the container is sealed and thereafter the sealed container is mixed. The mixing makes it possible to minimize clumping of chopped onions and to minimize forming dry spots in the rehydrated chopped onions. The mixing also makes it possible for the chopped onions to rapidly become rehydrated and acidified.

After mixing, the sealed container is inverted.

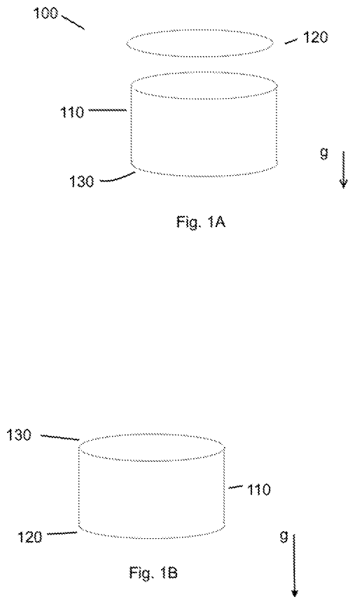

FIG. 1A shows an embodiment of a container 100, which includes an open compartment 110 and a cap 120. Upon adding the dehydrated chopped onions to the open compartment 110, gravity (g) pulls the chopped onions towards the container bottom 130. Upon adding the heated aqueous brine, gravity (g) facilitates settling of the chopped onions towards the container bottom 130.

The container 100 is capped by adding cap 120 to open compartment 110 in order to seal the container. Thereafter the container is mixed. In one example, the container is mixed by turning the container onto its side and rolling. The rolling of the container mixes and agitates the contents of the container.

After mixing, the container is inverted such that gravity (g) facilitates settling of the chopped onions towards the sealed container's cap 120. Inverting makes it possible for the chopped onions to more fully rehydrate and impedes separation of the rehydrated chopped onion into a visible layer.

FIG. 1B shows an embodiment of an inverted sealed container.

The inverted container is held in an environment for a period of time sufficient to sterilize the chopped onions and optional contents by maintaining the temperature of the aqueous brine above 175° F. for 123 minutes.

After a sufficient period of time passes, the container is cooled by removing it from the environment and storing the food product before use.

The dehydrated chopped onion is filled into a container, then topped with hot acid brine. After filling to a desired level, the container is then capped and mixed to minimize clumping or dry spots, and all ingredients in the container are capable of achieving a rapid rehydration and acidification. After sufficiently mixing, the container is then inverted and kept inverted throughout the heating and cooling steps. During heating, the container and its ingredients are held for a time and a temperature sufficient to achieve commercial sterility.

It has been discovered that if the product is kept upright (non-inverted), the container's contents, which include onion, will not fully rehydrate in the container and separation of the onion will be visible later after the processed and capped container is thereafter opened. It has been unexpectedly discovered that inversion of the container during heating and cooling makes an improvement possible. After cooling, the product is reinverted or re-invertible before labelling and final packaging of the container containing the rehydrated onions.

The brine or acidified solution is made of an acid blend sufficient to maintain the quality and safety of the chopped onions on a shelf at ambient temperatures for up to, but not limited to, twelve months.

### Example 2

In the example below, the embodiment refers to peeled onions. But in any embodiment herein, the peeled onions may be accompanied by other vegetables and/or spices.

Peeled onions are added to a volumetric filler to a desired amount, e.g., 14 oz, 28 oz, 60 oz. or any desired amount.

The peeled onions are added to an open compartment of a container. Aqueous brine consisting of water and sodium bisulfite is added to a desired level to the open compartment.

An aqueous acid solution of three acids—lactic acid, citric acid, and ascorbic acid— and water is made by mixing the conjugate bases of the three acids in water.

The aqueous acid solution is added to the aqueous brine consisting of water and sodium bisulfite. The resultant aqueous brine has a pH of 1.7.

The compartment is sealed and the contents are mixed. The container is invented as described in Example 1. The inverted container is heated so that the contents of the sealed compartment are above 173° F. for 160 minutes.

Afterwards, the container is cooled and storing the food product before use.

In some embodiments, the method further comprises transferring, from the first compartment of the first container to a second compartment of a second container, the onions in an aqueous brine comprising lactic acid, citric acid, at least one acid chosen from ascorbic acid and sodium bisulfite, and water, and wherein the aqueous brine has a pH ranging from 1.5 to 4.5. In some embodiments, the method further comprises thereafter sealing the second container.

### Example 3. Cold Fill Process

An aqueous acid solution of three acids—lactic acid, citric acid, and ascorbic acid—and water is made by mixing the conjugate bases of the three acids in water.

The aqueous acid solution is added to a precursor to the aqueous brine consisting of water and sodium chloride. The resultant aqueous brine has a pH of 1.7.

Peeled onions are added to the aqueous acid solution in which there is 75% onion and 25% brine. The resultant pH of the mixture has a pH ranging from 1.5-4.5.

The mixture of onion and brine is then heated to 173° F. for 160 minutes then cooled to below 120° F. and transferred to a filler.

A sanitized container is then filled with the cooled onion mixture and sealed by a sanitized cap.

The product is then stored before use.

### Example 4. Hot Fill

In Example 1, the lactic and citric acids are replaced with phosphoric acid. The quality and safety of the chopped onions are maintainable on the shelf at ambient temperature for a period of time.

### Example 5

In Example 5, the lactic acid is replaced with phosphoric acid in the form of sodium phosphate. The brine pH is 1.6.

### Example 6. Cold Fill Process

In Example 3, the citric acid is replaced with hexametaphosphate. The brine pH is 1.8. The product is storable before use.

### Example 7. Four-Stage Fill Process

In the example below, the embodiment refers to chopped onions. But, as discussed previously, in any embodiment herein, the chopped onions may be accompanied by other vegetables and/or spices.

A glass or polyethylene terephthalate container is cleaned.

A four-stage fill process is used to fill the container. First, a dry powder of sodium metabisulfite (SMBS) is dosed into the container. The SMBS is present in about 0.03 wt/wt %. Next, liquid is dosed into the container. In particular at least one heat stable natural flavor is added in 0.60 wt/wt %. Dehydrated onion cut in about ¼ inch pieces are then added to the container in about 18.80 wt/wt %. Finally, an acidified solution or brine including at least water and a food grade acid is added to a container. Specifically, about 80.0% water and about 0.57% phosphoric acid are added to the container. The pH is about 3.9 or less with a brine acid content of about 1.0% acid or less. The heating temperature is about 195° F. or greater with a jar fill temperature of about 195° F. or greater. The container is capped within 30 seconds of adding the water and food grade acid and the container is placed on its side and rolled to agitate the contents for about 45 seconds or less. The container is then inverted on its cap for at least 2.2 minutes, maintaining a temperature of at least about 165° F. The container may then be stood upright. For instance, the container housing the onion food product is subjected to thermal pasteurization for at least about 15.4 minutes, maintaining a temperature of at least about 165° F.

The onion food product is then cooled to a temperature of about 114° F. and the ingredients equilibrate after about 24 hours after cooling.

The onion food product made in accordance with this process maintains the quality and safety of the chopped onions on a shelf at ambient temperatures for up to twenty-four months.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An onion food product comprising onions, sodium metabisulfite, water, at least one food-grade acid selected from the group consisting of citric acid, ascorbic acid, fumaric acid, lactic acid, malic acid, and phosphoric acid, and at least one heat stable flavor.

2. The onion food product of claim 1, wherein the onions have a form chosen from chopped, diced, minced, and sliced onions.

3. The onion food product of claim 1, wherein the onions are dehydrated, fresh or frozen onions.

4. The onion food product of claim 1, further comprising at least one spice, and one additional vegetable ingredient different from onion.

5. The onion food product of claim 4 wherein onion is the major vegetable ingredient by weight of any vegetables and spices.

6. The onion food product of claim 1 wherein the sodium metabisulfite comprises a dry powder.

7. The onion food product of claim 1, wherein
a. the sodium metabisulfite is present in an amount ranging from about 0.01-0.1% wt/wt % relative to the total weight of the onion food product;
b. the heat stable flavor is present in an amount ranging from about 0.1-2%; wt/wt % relative to the total weight of the onion food product;
c. the onion is present in an amount ranging from about 15-25% wt/wt % relative to the total weight of the onion food product;
d. the water is present in an amount ranging from about 71-84% wt/wt % relative to the total weight of the onion food product; and
e. the food grade acid is present in an amount ranging from about 0.1-2% wt/wt % relative to the total weight of the onion food product.

8. The onion product of claim 1, wherein the onion food product is housed in a container.

9. The onion product of claim 1, wherein the onion product has a shelf life of about 24 months when stored at ambient temperature.

10. The onion product of claim 1 wherein the heat-stable flavor is a natural flavor.

11. A method of making an onion food product, comprising the steps of: providing a container, filling the container with at least: sodium metabisulfite; at least one heat stable flavor; onions; and an acidified solution comprising one or more acids chosen from lactic acid, citric acid, and phosphoric acid, and water, and wherein the acidified solution has a pH of about 4.0 or less and a brine acid of 1.0% acid or less, capping the container, agitating the container, inverting the container, thermally pasteurizing the container, and cooling the container.

12. The method of claim 11 further comprising performing filling step in the following order:
(1) dosing sodium metabisulfite;
(2) adding at least one heat stable flavor;
(3) adding onion; and
(4) adding the acidified solution comprising water and the one or more acids.

13. The method of claim 11 wherein the
a. the sodium metabisulfite is added in an amount ranging from about 0.01-0.1% wt/wt % relative to the total weight of the onion food product;
b. the heat stable flavor is added in an amount ranging from about 0.1-2%; wt/wt % relative to the total weight of the onion food product;
c. the onion is added in an amount ranging from about 15-25% wt/wt % relative to the total weight of the onion food product;
d. the water is added in an amount ranging from about 71-84% wt/wt % relative to the total weight of the onion food product; and
e. the food grade acid is added in an amount ranging from about 0.1-2% wt/wt % relative to the total weight of the onion food product.

14. The method of claim 11, wherein the container is capped within 30 seconds or less of filling.

15. The method of claim 11, wherein the step of adding an acidified solution is the final step for filling the container prior to the capping.

16. The method of claim 11, wherein the container is inverted for a minimum of about 2.2 minutes while maintaining a temperature of about 165° F.

17. The method of claim 11, wherein the container is agitated for about 45 seconds or less.

18. The method of claim 11, wherein the onions are dehydrated.

19. The method of claim 11 further comprising adding at least one spice, and one additional vegetable ingredient different from onion.

20. The method of claim 11 wherein the heat stable flavor is a natural flavor.
